(19) United States
(12) Patent Application Publication
(10) Pub. No.: US 2020/0001463 A1
(43) Pub. Date: Jan. 2, 2020

(54) SYSTEM AND METHOD FOR COOKING ROBOT

(71) Applicant: LG ELECTRONICS INC., Seoul (KR)

(72) Inventors: Minjung KIM, Seoul (KR); Jungsik KIM, Seoul (KR)

(73) Assignee: LG ELECTRONICS INC., Seoul (KR)

(21) Appl. No.: 16/565,802

(22) Filed: Sep. 10, 2019

(30) Foreign Application Priority Data
Aug. 5, 2019 (KR) 10-2019-0095222

(51) Int. Cl. B25J 9/16; B25J 11/00; G06K 9/00

(52) U.S. Cl. CPC B25J 9/1697; B25J 11/0045; B25J 9/161; G06K 9/00201; B25J 9/1661

(57) ABSTRACT

A cooking robot system and a control method thereof is provided. The cooking robot system includes: a robot configured to acquire the image of the object through a sensing unit and generate image data to transmit the image data to a server, or receive a motion of a user with respect to the object from an input unit upon a request of the server and generate demonstration data to transmit the demonstration data to the server, and implement a motion for the object based on motion data corresponding to the image data or the demonstration data; and a server configured to detect the motion data for the object and control the robot by searching for a motion corresponding to the image data via a web server to generate the motion data or by generating the motion data corresponding to the demonstration data.

### CROSS-REFERENCE TO RELATED APPLICATIONS

The present application claims priority under 35 U.S.C. 119 and 35 U.S.C. 365 to Korean Patent Application No. 10-2019-0095222 (filed on Aug. 5, 2019), which is hereby incorporated by reference in its entirety.

### BACKGROUND

In general, a robot refers to machine that automatically processes a given task or operates using a capability of the robot. Applications of the robot are generally classified into various fields such as an industrial, medical, astronautic, and submarine field. Recently, communication robots capable of communicating or interacting with humans through voices or gestures tend to increase.

The communication robot may include a guide robot placed in a specific place to guide a user to various information, or various kinds of robots, such as a home robot provided at home. In addition, the communication robot may include an educational robot that guides or assists learning of a learner by interacting with the learner.

The communication robot may be implemented to interact with the user or learner using various configurations. For example, the communication robot may include a microphone that acquires sounds generated around the robot, or a camera that acquires images around the robot.

Meanwhile, the robot has been increasingly taking over a role to make food in large quantities or cook dishes according to precise recipes instead of a human cook. In particular, a robot, which performs cooking in a manner that progresses of the food being cooked are tracked using a camera attached to a joint, arm or head of the robot and the robot cooks based on the processes, has been developed and actually applied.

In this regard, the conventional U.S. Pat. No. 9,815,191 (METHODS AND SYSTEMS FOR FOOD PREPARATION IN A ROBOTIC COOKING KITCHEN) discloses a robot that cooks by accurately reproducing movements and timings of a chef from recorded files.

However, since the robot is controlled by assuming that a container having an accurate shape is placed at an accurate position when the cooking is actually performed, the robot cannot be controlled when the container is not previously recorded or a motion is not preset.

### SUMMARY

The embodiments provides a motion learning system and a control method thereof, upon providing a motion of an object to a robot, to provide the motion for the object even when an existing recognized object is not provided.

In addition, the embodiments also provide a cooking robot system and a control method thereof to control a robot, upon reproducing a motion, through an input by a user or a search from a web server by a robot.

To this end, the embodiments provides a motion learning system using a server-based artificial intelligence cooking robot that recognizes an image of an object to implement a motion. The motion learning system includes: a robot configured to acquire the image of the object through a sensing unit and generate image data to transmit the image data to a server, or receive a motion of a user with respect to the object from an input unit upon a request of the server and generate demonstration data to transmit the demonstration data to the server, and implement a motion for the object based on motion data corresponding to the image data or the demonstration data; and a server configured to detect the motion data for the object and control the robot by searching for a motion corresponding to the image data via a web server to generate the motion data or by generating the motion data corresponding to the demonstration data.

According to the embodiments, the robot may include the sensing unit configured to generate the image data by acquiring the image of the object; and the input unit configured to generate the demonstration data by receiving the motion of the user upon the request of the server.

According to the embodiments, the robot may further include a communication unit configured to transmit the data acquired from the sensing unit and the input unit to the server.

According to the embodiments, the sensing unit may use at least one of an RGB sensor or a depth sensor to generate the image data by recognizing the object, and use an RGBD recorder to generate the demonstration data.

According to the embodiments, the robot may further include an output unit including a speaker or a display to notify a current status or progress of the robot to an outside of the robot by using a voice or image.

According to the embodiments, the server may include a database configured to store at least one of the image data for the object, the demonstration data, or the motion data; and a processor configured to search for and compare the image data received from the robot in the database, request the demonstration data to the robot when matched data is absent, and transmit the motion data to control the robot.

According to the embodiments, the server may further include a communication module configured to receive the data acquired from the sensing unit and the input unit and transmit the motion data to the robot.

According to the embodiments, the processor may further include a search unit configured to search for and compare the image data received from the robot from the database; a calculation unit configured to estimate a motion of the user from the demonstration data received from the robot; and a conversion unit configured to generate motion data for converting the motion estimated by the calculation unit into a motion of the robot.

In addition, the embodiments provides a method of controlling a motion learning system using a server-based artificial intelligence cooking robot, the method includes: a first step in which a processor of a server, which receives image data of an object acquired through a sensing unit of the robot, searches for and compares the image data in a database; a second step of searching for demonstration data that represents a motion for a new object from a web server when the image data is determined as new image data not stored in the database, and requesting demonstration data for the new object from a user when the demonstration data is absent; and a third step in which the processor receives the demonstration data for the new object to store the received demonstration data in the database, and generates motion data corresponding to the image data to transmit the generated motion data to the robot, and the robot performs the motion for the object.

According to the embodiments, the first step may further include generating the motion data from the demonstration data when the demonstration data matching the image data is present in the database, and transmitting the motion data to the robot to perform a motion for the object.

According to the embodiments, the second step may further include: extracting, by the processor, a video matching the image data from the web server; and generating motion data by extracting the motion for the object from the video.

According to the embodiments, the second step may further include requesting for the demonstration data from the user when the video matching the image data is absent from the web server.

According to the embodiments, the third step may further include estimating a motion of the user through a calculation unit from the demonstration data received from the robot; and generating, by a conversion unit, motion data that converts the motion estimated by the calculation unit into a motion of the robot.

The third step may further include re-searching for a video from the web server when the motion of the robot is not converted.

The third step may further include generating a motion model of the robot with respect to the object by accumulating at least one of the image data, the demonstration data, or the motion data in the database.

The details of one or more embodiments are set forth in the accompanying drawings and the description below. Other features will be apparent from the description and drawings, and from the claims.

### BRIEF DESCRIPTION OF THE DRAWINGS

FIG. 1 illustrates an AI device including a robot according to one embodiment.

FIG. 2 illustrates an AI server connected to the robot according to one embodiment.

FIG. 3 illustrates an AI system according to one embodiment.

FIG. 4 illustrates a block diagram of a cooking robot system according to one embodiment.

FIG. 5 illustrates a state in which demonstration data and motion data are stored in the database according to one embodiment.

FIG. 6 illustrates a flowchart for a method of controlling the cooking robot system according to one embodiment.

FIG. 7 illustrates a detailed flowchart for the method of controlling the cooking robot system according to one embodiment.

FIG. 8 illustrates a control and a data movement order between a server, robot and user according to one embodiment.

FIG. 9 illustrates a state in which image data in a first step is generated according to one embodiment.

FIG. 10 illustrates a state in which demonstration data in a second step is extracted according to one embodiment.

FIG. 11 illustrates a state in which the robot is controlled using the motion data according to one embodiment.

### DETAILED DESCRIPTION OF THE EMBODIMENTS

Hereinafter, the present disclosure will be described in detail with reference to the accompanying drawings. The present disclosure is not limited to or restricted by the illustrative embodiments. The same reference numerals in the drawings denote members that perform substantially the same functions.

The objectives and effects of the present disclosure may be naturally or clearly understood based on the following description, and the objectives and effects of the present disclosure are not limited only by the following description. Further, in the following description of the embodiments, the detailed description of known techniques related to the present disclosure will be omitted when it possibly makes the subject matter of the present disclosure unclear unnecessarily.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

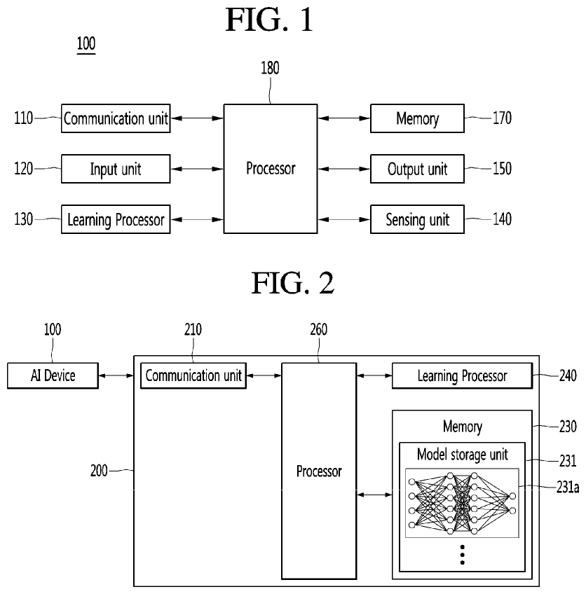

FIG. 1 illustrates an AI device 100 including a robot according to the embodiments.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 connected to a robot according to the embodiments.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

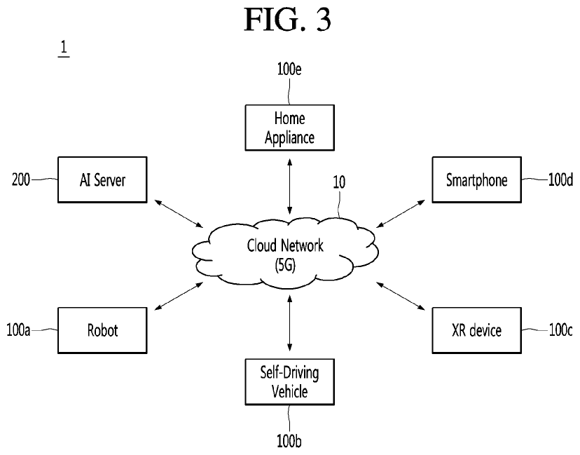

FIG. 3 illustrates an AI system 1 according to the embodiments.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

The robot and server of the embodiments may correspond to the AI device and the AI server shown in FIGS. 1 and 2, respectively. Sub-components may correspond to examples of the AI device 100 and the AI server 200 described above. In other words, components included in the AI device 100 of FIG. 1 and components included in the AI server 200 of FIG. 2 may be included in the robot and the server of the embodiments.

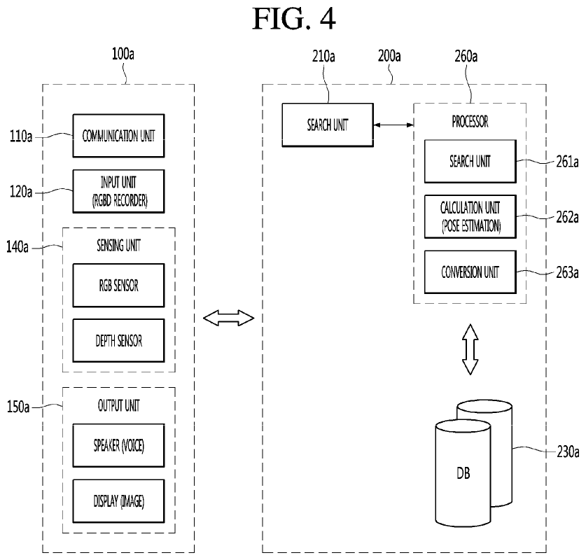

FIG. 4 illustrates a block diagram of a cooking robot system according to one embodiment.

Referring to FIG. 4, the robot may include a communication unit 110a, an input unit 120a, a sensing unit 140a, and an output unit 150a, and the server may include a processor 260a, a communication module, and a database 230a.

The sensing unit 140a of the robot may include an RGB sensor and a depth sensor, the output unit 150a may include a speaker and a display, and the processor 260a of the server may include a search unit 261a, an calculation unit 262a, and a conversion unit 263a.

In a cooking robot system using a server-based artificial intelligence cooking robot that recognizes an image of an object to implement a motion, the robot may generate image data by acquiring the image of the object through the sensing unit 140a and transmit the image data to the server.

The sensing unit 140a of the robot may generate the image data by acquiring the image of the object, and may use at least one of an RGB sensor or a depth sensor to generate the image data by recognizing the object, and use an RGBD recorder to generate the demonstration data.

The sensing unit 140a may use a technology for object recognition based on depth information of a space and an object using a red/green/blue-depth (RGB-D) device. According to the embodiments, the object may be a container configured to contain a sauce.

The sensing unit 140a may output RGB-D image data by extracting a region based on an RGB-D image to accurately separate the container from a background, and matching the RGB image with the depth image that are inputted to the region.

The sensing unit 140a may extract a region of interest by removing a background image from the matched RGB-D image data and applying an approximate region of the container and a three-dimensional model preset to the region to the image obtained by removing the background image.

The sensing unit 140a may correct the depth image by analyzing the similarity of the matched RGB-D image data to the extracted region of interest.

The sensing unit 140a may generate image data through the above process and transmit the image data to the server through the communication unit 110a. The server may retrieve whether demonstration data related to the container exists using the image data.

The robot may generate the demonstration data by receiving a motion of the user for the object from the input unit 120a upon a request of the server, transmit the demonstration data to the server, and implement the motion for the object by using motion data corresponding to the image data or the demonstration data.

The processor 260a may compare the image data of the sensing unit 140a with previously stored data and retrieve whether a motion related to the corresponding container exists. According to the embodiments, the motion may be regarded as a concept similar to the motion data, and data implemented to enable the processor 260a or a computer to recognize the motion may be regarded as the motion data.

The motion data refers to data obtained by matching a container with a motion that controls the container, and the motion data may have various formats according to the embodiments and may include all kinds of data that control a motion of the robot.

According to one embodiment, when the processor 260a retrieves the image data transmitted from the sensing unit 140a and no data is retrieved, the processor 260a may retrieve the image data in the web server or request the user to transmit demonstration data corresponding to the image data.

The server may detect the motion data of the object, and generate the motion data or generate the motion data corresponding to the demonstration data by retrieving a motion corresponding to the image data through the web server, so that the robot may be controlled.

The input unit 120a of the robot may generate the demonstration data by receiving the motion of the user for the object upon the request of the server. The input unit 120a of the robot may predict a performance of the motion by extracting feature points from the video inputted by the user.

The user may input an image including a container and a motion matching the container, and the robot may generate image data using the above image.

The communication unit 110a of the robot may transmit the image data of the sensing unit 140a or the demonstration data acquired from the input unit 120a to a server, and thus the processor 260a may generate the motion data.

The communication unit 110a may include wired communication or wireless communication, in which the wireless communication may include cellular communication using at least one of, for example, LTE, LTE Advance (LTE-A), code division multiple access (CDMA), wideband CDMA (WCDMA), universal mobile telecommunications system (UMTS), wireless broadband (WiBro), or global network for mobile communications (GSM).

In the embodiments, the wireless communication may include at least one of wireless fidelity (WiFi), light fidelity (LiFi), Bluetooth, Bluetooth low energy (BLE), Zigbee, near field communication (NFC), magnetic secure transmission (MST), radio frequency (RF), or body area network (BAN).

In the embodiments, the wired communication may include at least one of universal serial bus (USB), high definition multimedia interface (HDMI), recommended standard232 (RS-232), power line communication, plain old telephone service (POTS), or the like.

In the embodiments, the network may include at least one of telecommunication network, computer network (such as LAN or WAN), Internet, or telephone network.

The output unit 150a of the robot may have a speaker or a display device to notify a current status or progress of the robot to an outside of the robot by using a voice or image.

According to the embodiments, the current status refers to a status currently being progressed such as generating image data, transmitting or receiving a data request, or performing a motion, and the progress may indicate a communication situation such as a progress of transmission or reception with the server or the user.

The database 230a of the server may store at least one of the image data, the demonstration data, or the motion data with respect to the object. The database 230a will be described later with reference to FIG. 6.

When the processor 260a of the server searches for and compares the image data received from the robot in the database 230a and matched data exists, the processor 260a may control the robot according to the motion data corresponding to the matched data.

The processor 260a of the server may include a search unit 261a, and the search unit 261a may search for and compare the image data received from the robot in the database 230a. When the search unit 261a may primarily search for the image data in the database 230a and no data is found, the search unit 261a may conduct a search using a search word corresponding to the container from a web server such as the Internet, and thus data related to the container corresponding to the image data may be retrieved.

When no data is found by the search unit 261a, the demonstration data may be requested to the robot. Accordingly, the robot may request a demonstration video to the user, and the robot may generate demonstration data using the image received through the input unit 120a and transmit the demonstration data to the server.

When the processor 260a of the server searches for and compares the image data received from the robot in the database 230a and no matched data exists, the demonstration data may be retrieved through the web server such as the Internet.

The processor 260a of the server may request the demonstration data to the robot, and may control the robot by transmitting the motion data.

Through the process as described above, the calculation unit 262a of the processor 260a may estimate a motion of the user from the retrieved demonstration data or the demonstration data received from the robot.

The processor 260a may be set to receive demonstration data for training a video classification model, extract features of the demonstration data based on label information of the received demonstration data, and train the video classification model based on the extracted features.

According to the embodiments, the demonstration data may be video data. In one embodiment, the demonstration data may be classified video data, and the classified video data may be labeled video data.

In another embodiment, a label may be at least one category or attribute determined according to at least one of content (topic or genre) or format of the video data. The label may be at least one category or attribute corresponding to one video.

The communication module of the server may receive data acquired from the sensing unit 140a and the input unit 120a and transmit the motion data to the robot.

In the above process, the conversion unit 263a of the processor 260a may generate motion data for converting the motion estimated by the calculation unit 262a into a motion of the robot.

The processor 260a may have difficulty to apply the retrieved image corresponding to image data or the demonstration data generated, which is based on a human motion, to the robot. In this case, the conversion unit 263a may generate motion data implemented using a programming language for driving the robot suitable for motions of the robot.

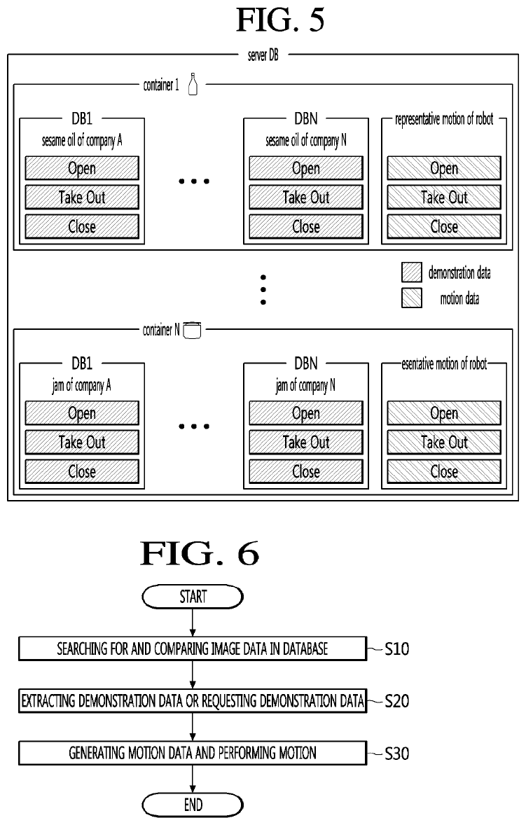

FIG. 5 illustrates a state in which the demonstration data and the motion data are stored in the database 230a according to one embodiment.

Referring to FIG. 5, the database 230a may store at least one of the image data, the demonstration data, or the motion data with respect to the object.

The database 230a may classify each container and store a motion to be performed for the container. The demonstration data may be primarily classified for each container, and the motion data matching the demonstration data may be secondarily classified and stored to control the motion of the robot.

A control method of the cooking robot system for controlling the artificial intelligence robot using the above-described cooking robot system will be described later.

FIG. 6 illustrates a flowchart for the method of controlling the cooking robot system according to one embodiment.

Referring to FIG. 6, the control method of the cooking robot system may include: a first step S10 of searching for and comparing image data in the database 230a; a second step S20 of extracting demonstration data or requesting the demonstration data; and a third step S30 of generating motion data to perform a motion.

The first step S10 may include: performing a motion for the object by generating motion data from the demonstration data and transmitting the motion data to the robot when the demonstration data matching the image data exists in the database 230a.

The second step S20 may include: extracting, by the processor 260a, a video matching the image data from the web server; generating motion data by extracting the motion for the object from the video; and requesting for the demonstration data to the user when the video matching the image data is absent from the web server.

The third step S30 may include: estimating a motion of the user through a calculation unit 262a from the demonstration data received from the robot; and generating, by a conversion unit 263a, motion data that converts the motion estimated by the calculation unit 262a into a motion of the robot.

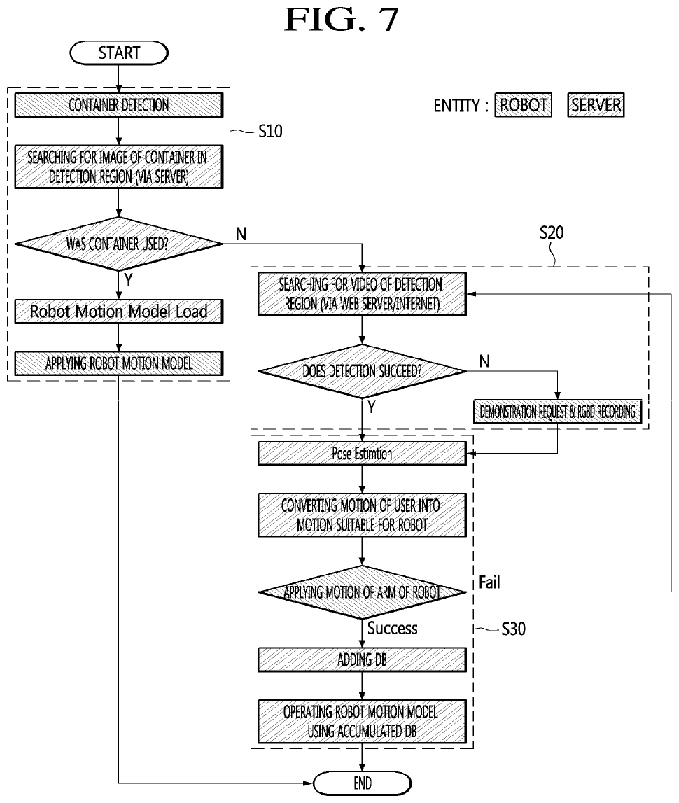

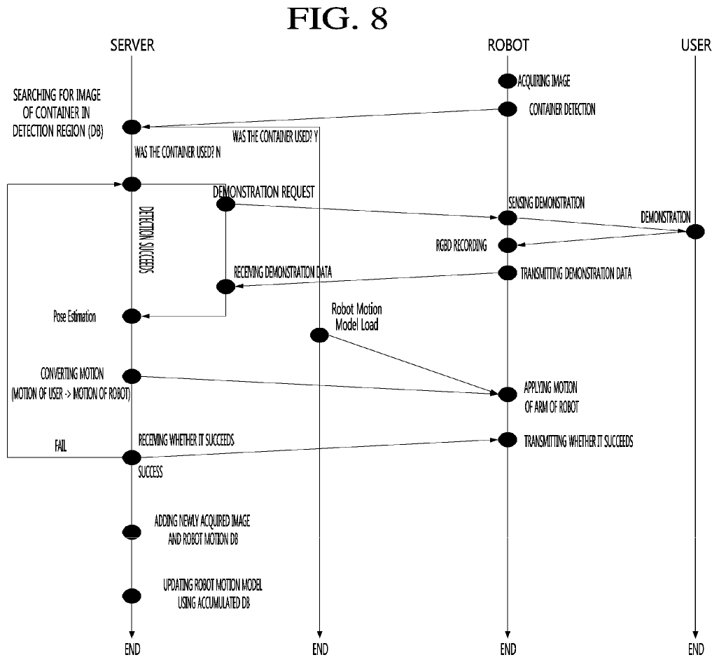

The above-described first step S10 to third step S30 will be described in detail later with reference to FIGS. 7 and 8.

FIG. 7 illustrates a detailed flowchart for the method of controlling the cooking robot system according to one embodiment.

FIG. 7 shows detailed processes of first step S10 to third step S30. Referring to FIG. 8, the embodiments may be understood more clearly through the process of transmitting and receiving data between the robot and the server.

In first step S10, the processor 260a of the server, which receives the image data of the object acquired through the sensing unit 140a of the robot, searches for and compares the image data in the database 230a.

The processor 260a of the server may search for and compare the image data received from the robot in the database 230a, and the processor 260a may control the robot according to the motion data corresponding to the matched data when data matching the image data exists.

The processor 260a of the server may include a search unit 261a, and the search unit 261a may search for and compare the image data received from the robot in the database 230a. When the search unit 261a may primarily retrieve the image data in the database 230a and no data is retrieved, the search unit 261a may conduct a search using a search word corresponding to the container from a web server such as the Internet, and thus data related to the container corresponding to the image data may be retrieved.

The second step S20 includes: searching for demonstration data that represents a motion for a new object from a web server when the image data is determined as new image data not stored in the database 230a, and requesting demonstration data for the new object to the user when the retrieved demonstration data is absent;

When no data is retrieved by the search unit 261a, the demonstration data may be requested to the robot. Accordingly, the robot may request a demonstration video to the user, and the robot may generate demonstration data using the image received through the input unit 120a and transmit the demonstration data to the server.

The user may access the input unit 120a of the robot and input an image upon the request of the robot. In other words, the robot may request the demonstration video to the user, and the robot may generate demonstration data using the image received through the input unit 120a and transmit the demonstration data to the server.

The processor 260a may estimate a motion of the user from the retrieved demonstration data or the demonstration data received from the robot. When the motion of the robot is not converted, a step of re-searching for a video from the web server may be further included.

The calculation unit 262a of the processor 260a may functions as in the above process, and the calculation unit 262a may receive the demonstration data for training the video classification model, and extract features of the demonstration data based on label information of the received demonstration data.

In the third step S30, the processor 260a receives the demonstration data for the new object to store the received demonstration data in the database 230a, and generates motion data corresponding to the image data to transmit the generated motion data to the robot, and the robot performs the motion for the object.

In the above process, the conversion unit 263a of the processor 260a may generate motion data for converting the motion estimated by the calculation unit 262a into a motion of the robot.

The processor 260a may have difficulty to apply the retrieved image corresponding to image data or the demonstration data generated based on a human motion to the robot. In this case, the conversion unit 263a may generate motion data implemented using a programming language for driving the robot suitable for motions of the robot.

FIG. 8 illustrates a control and a data movement order between the server, robot and user according to one embodiment.

FIG. 8 shows the steps in FIG. 7 into a ladder diagram, in which a process of executing each step is shown based on the server, robot and user as entities.

According to the embodiments, the robot may acquire an image for an object, that is, a container, generates image data, and transmits the image data to the server. The server may primarily searches for the image data in the database 230a based on the image data corresponding to the container in a detection region, and then secondarily searches for the image data in the web server.

When any video is not found, the server may request demonstration data to the robot, and the robot may request the user to input the demonstration data.

The user may input a demonstrated image through the input unit 120a of the robot, and the robot may generate demonstration data for the input and transmit the demonstration data to the server. The server may receive the demonstration data and estimate and extract a motion corresponding to the container.

The server may generate motion data implemented using a programming language for driving the robot suitable for motions of the robot, through the conversion unit 263a of the processor 260a. The robot may be controlled by transmitting the motion data to the robot.

Through the above first to third steps, at least one of the image data, the demonstration data, or the motion data is accumulated to the database 230a, so that a motion model of the robot may be generated with respect to the object.

The motion model of the robot enables the motion to be performed according to the stored motion data in the case of an existing container. In the case of a new container, the data is accumulated through the above process, and thus the motion of the robot may be performed.

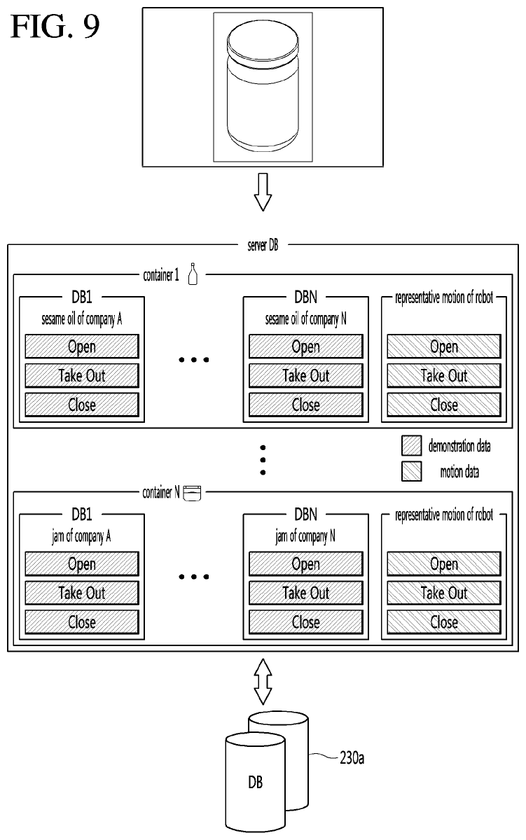

FIG. 9 illustrates a state in which the image data in the first step is generated according to one embodiment.

Referring to FIG. 9, the robot may ensure a detection region of the container using the camera therein or the like, recognizes the container in the region, generate image data, and transmit the image data to the server, match demonstration data, motion data or the like corresponding to the image data to the container, and thus store the matched data in the database 230a.

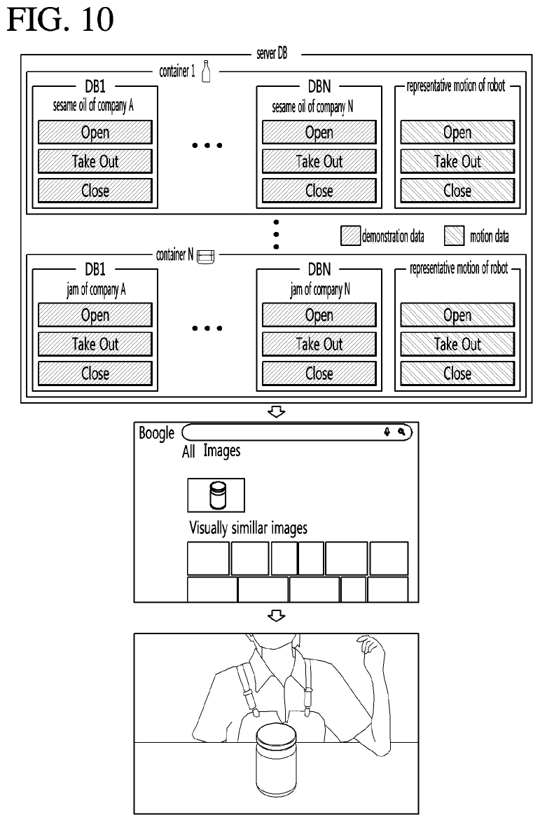

FIG. 10 illustrates a state in which the demonstration data in the second step is extracted according to one embodiment.

FIG. 10 illustrates a state in which the corresponding image is extracted after the robot is connected to the web server, when the image data is retrieved from database 230a and no image is found. The processor 260a may generate a search word suitable for the container, and may detect a related image using the search word through the Internet or a search engine.

The calculation unit 262a of the processor 260a may estimate a motion of the user from the retrieved demonstration data or the demonstration data received from the robot.

The processor 260a may be set to receive demonstration data for training the video classification model, extract features of the demonstration data based on label information of the received demonstration data, and train the video classification model based on the extracted features.

According to the embodiments, the demonstration data may be video data. In one embodiment, the demonstration data may be classified video data, and the classified video data may be labeled video data.

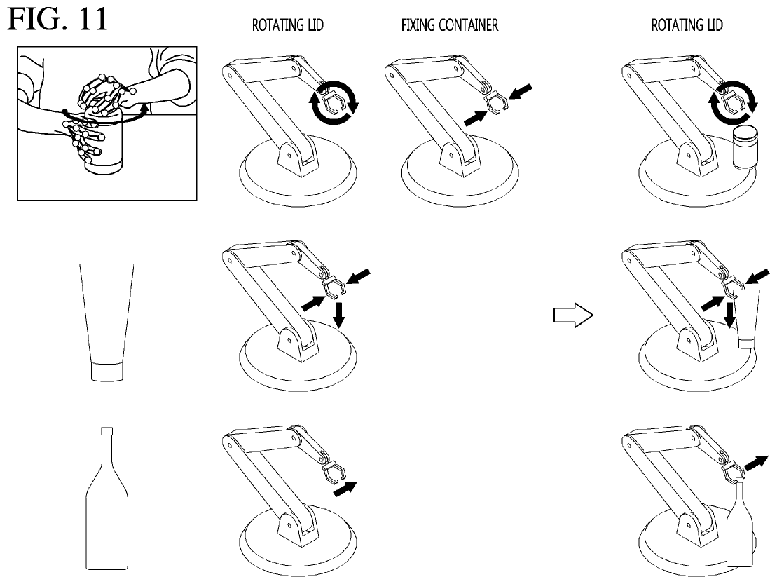

FIG. 11 illustrates a state in which the robot is controlled using the motion data according to one embodiment.

FIG. 11 shows that the robot performs motions for containers by generating motion data suitable for the containers. The calculation unit 262a of the processor 260a may generate motion data from the retrieved demonstration data or the demonstration data received from the robot, and control the robot.

In the embodiments, a video highly relevant to an image of a commercial container is retrieved, and a section about opening a lid of a commercial food material container, a section about taking a food material from the container, a section about closing the lid, or the like is extracted from the image (that is, action is recognized), so that the video can be automatically retrieved.

Pose/skeleton information may be extracted from the retrieved video (DNN) and a plurality of images may be used so that the reliability of the pose/skeleton information can be increased. Continuous motion information of the extracted skeleton may be converted into a motion suitable for hardware of the robot so that the cooking robot system using the robot for various kinds of commercial sauce containers can be established.

Further, in the embodiments, since the motion is reproduced using learned content, a food material is not required to be placed in a predetermined container, and the food material can be taken out of the container even when a shape of the container containing the food material is changed.

Although the disclosure has been described in detail with reference to the representative embodiments, it will be apparent that a person having ordinary skill in the art may carry out various deformations and modifications for the aforementioned embodiments within the scope without departing from the embodiments. Therefore, the scope of the present disclosure should not be limited to the aforementioned embodiments, and should be determined by all deformations or modifications derived from the following claims and the equivalent thereof.

What is claimed is:

1. A cooking robot system, which is server-based and recognizes an image of an object to implement a motion, the cooking robot system comprising:
a robot configured to:
acquire the image of the object through a sensing unit and generate image data to transmit the image data to a server, or receive a motion of a user with respect to the object from an input unit upon a request of the server and generate demonstration data to transmit the demonstration data to the server, and
implement a motion for the object based on motion data corresponding to the image data or the demonstration data; and
a server configured to detect the motion data for the object and control the robot by searching for a motion corresponding to the image data via a web server to generate the motion data or by generating the motion data corresponding to the demonstration data.

2. The cooking robot system according to claim 1, wherein the cooking robot system interworks with an artificial intelligence server and is implemented based on an artificial intelligence to generate the motion data by automatically recognizing the image of the object.

3. The cooking robot system according to claim 1, wherein the robot includes:
the sensing unit configured to generate the image data by acquiring the image of the object; and
the input unit configured to generate the demonstration data by receiving the motion of the user upon the request of the server.

4. The cooking robot system according to claim 3, wherein the robot further includes:
a communication unit configured to transmit the data acquired from the sensing unit or the input unit to the server.

5. The cooking robot system according to claim 3, wherein the sensing unit uses at least one of an RGB sensor or a depth sensor to generate the image data by recognizing the object, and uses an RGBD recorder to generate the demonstration data.

6. The cooking robot system according to claim 3, wherein the robot further includes:
an output unit including a speaker or a display to notify a current status or progress of the robot to an outside of the robot by using a voice or image.

7. The cooking robot system according to claim 2, wherein the server includes:
a database configured to store at least one of the image data for the object, the demonstration data, or the motion data; and
a processor configured to:
search for and compare the image data received from the robot in the database,
request the demonstration data to the robot when matched data is absent, and
transmit the motion data to control the robot.

8. The cooking robot system according to claim 7, wherein the server further includes:
a communication module configured to receive the data acquired from the sensing unit and the input unit and transmit the motion data to the robot.

9. The cooking robot system according to claim 7, wherein the processor includes:
a search unit configured to search for and compare the image data received from the robot in the database;
a calculation unit configured to estimate a motion of the user from the demonstration data received from the robot; and
a conversion unit configured to generate motion data for converting the motion estimated by the calculation unit into a motion of the robot.

10. A method of controlling a cooking robot, the method comprising:
a first step of searching for and comparing image data in a database by a processor of a server that receives the image data of an object acquired through a sensing unit of a robot;
a second step of searching for demonstration data that represents a motion for a new object from a web server when the image data is determined as new image data not stored in the database, and requesting demonstration data with respect to the new object to a user when the demonstration data is absent; and
a third step of receiving the demonstration data for the new object by the processor to store the received demonstration data in the database and generating motion data corresponding to the image data by the processor to transmit the motion data to the robot, and performing the motion for the object by the robot.

11. The method according to claim 10, wherein the cooking robot interworks with an artificial intelligence server and is implemented based on an artificial intelligence to automatically recognize the image of the object to generate the motion data.

12. The method according to claim 11, wherein the first step includes:
generating the motion data from the demonstration data when the demonstration data matching the image data is present in the database; and
transmitting the motion data to the robot to perform a motion for the object.

13. The method according to claim 11, wherein the second step includes:
extracting a video matching the image data from the web server by the processor; and
generating motion data by extracting the motion for the object from the video.

14. The method according to claim 13, wherein the second step further includes:
requesting for the demonstration data to the user when the video matching the image data is absent from the web server.

15. The method according to claim 11, wherein the third step further includes:
estimating a motion of the user from the demonstration data received from the robot by a calculation unit; and
generating the motion data configured to convert the motion estimated by the calculation unit into a motion of the robot by a conversion unit.

16. The method according to claim 15, wherein the third step further includes:
re-searching for a video from the web server when the motion of the robot is not converted.

17. The method according to claim 11, wherein the third step further includes:
generating a motion model of the robot with respect to the object by accumulating at least one of the image data, the demonstration data, or the motion data into the database.
